(19) United States
(12) Patent Application Publication
(10) Pub. No.: US 2026/0304245 A1
(43) Pub. Date: Oct. 1, 2026

(54) METHODS AND SYSTEMS FOR SELF-OPTIMIZATION IN WIRELESS NETWORKS

(71) Applicant: Samsung Electronics Co., Ltd., Gyeonggi-do (KR)

(72) Inventors: Aby Kanneath ABRAHAM, Bangalore (IN); Vinay Kumar SHRIVASTAVA, Bangalore (IN); Sriganesh RAJENDRAN, Bangalore (IN)

(21) Appl. No.: 19/100,781

(22) PCT Filed: Aug. 2, 2023
(86) PCT No.: PCT/KR2023/011330

§ 371 Date: Feb. 3, 2025

(30) Foreign Application Priority Data
Aug. 3, 2022 (IN) 202241044515
Jun. 23, 2023 (IN) 202241044515

(51) Int. Cl. H04W 36/00; H04W 36/36

(52) U.S. Cl. CPC H04W 36/0069; H04W 36/0072; H04W 36/362

(57) ABSTRACT

The disclosure relates to a 5G or 6G communication system for supporting a higher data transmission rate.

### TECHNICAL FIELD

Embodiments disclosed herein relate to wireless networks, and more particularly to methods, a User Equipment (UE) and a network device for performing self-optimization in the wireless networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### DISCLOSURE OF INVENTION

### Technical Problem

The principal object of the embodiments herein is to disclose methods and systems for performing self-optimization for a plurality of scenarios in wireless networks, wherein reporting has been enhanced for Mobility Robustness Optimization (MRO) and Minimization Of Drive Tests (MDT) for scenarios, such as, but not limited to, SCG Failure handling, Successful PSCell Addition Report, Successful PSCell Change Report, Conditional PSCell Addition, Conditional PSCell change, SCG activation, NPN, NR-U, and so on.

Another object of the embodiments herein is to provide that UE reporting and related procedures for optimising PSCell Addition and PSCell Change in a wireless network.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

Accordingly, the embodiments herein provide methods for handling self-optimization in a wireless network. The method includes configuring or applying a configuration at a UE to log and report information about at least one of a Successful PSCell Addition and a Successful PSCell Change through an otherConfig including at least one threshold in a RRC reconfiguration. The configuration is configured by a network device. Further, the method includes storing, by the UE, information about at least one of the Successful PSCell Addition and the Successful PSCell Change at the UE during at least one of a PSCell change and a PSCell addition and upon exceeding the at least one threshold.

In an embodiment, the method includes storing at least one of: an identifier of a PCell, an identifier of a source PSCell, an identifier of a target PSCell for a Conditional PSCell Change (CPC), a PSCell identifier of a SCG in a Conditional PSCell Addition (CPA), a serving cell measurement result, a neighbour cell measurement result, a Bluetooth measurement result, a Wireless Local Area Network (WLAN) measurement result, location information, a measurement information for a delay on the SCG in information about the at least one of the Successful PSCell Addition and the Successful PSCell Change, and time elapsed between a CPAC execution towards a target cell and a corresponding latest CPAC configuration received for a selected target cell.

In an embodiment, the method includes indicating at least one of a T304-cause, a T310-cause, and a T312-cause based on the at least one threshold satisfied for the Successful PSCell Change.

In an embodiment, the method includes indicating a T304-cause based on the at least one threshold satisfied for the Successful PSCell Addition.

In an embodiment, the method includes indicating at least one of the information about Successful PSCell Addition and the Successful PSCell Change to the network device.

In an embodiment, the method includes reporting information about at least one of the Successful PSCell Addition and the Successful PSCell Change based on the at least one threshold.

In an embodiment, the method includes deleting the configuration at the UE during at least one of a RRC reestablishment procedure and a RRC Resume procedure.

In an embodiment, the at least one threshold is based on a RRC timer T310 or T312 applied in a source PSCell, configured by a source PSCell or any of an earlier PSCells and T304 configured by a target PSCell.

In an embodiment, at least one of the Successful PSCell Addition and the Successful PSCell Change is stored upon determining at least one a ratio in percentage of an elapsed timer to the configured timer is greater than the at least one threshold.

In an embodiment, configuring or applying the configuration at the UE includes receiving, by the UE, a capability request from the network device, sending, by the UE, a UE capability information to the network device based on the capability request, where the UE capability information includes a single bit to inform the network device that the UE is capable of storing and reporting information about at least one of the Successful PSCellChange and the Successful PSCell Addition, receiving, by the UE, the RRC Reconfiguration including the configuration from the network device in a RRC information element (IE) OtherConfig, and configuring the configuration at the UE based on the RRC Reconfiguration. The network device sends other configuration to the UE only if the UE has indicated the capability.

In an embodiment, the at least one threshold comprises at least one of a T310 threshold, a T312 threshold, and a T304 threshold, wherein the logging is performed upon successfully completing a Random Access procedure, while triggering for a reconfiguration WithSync in spCellConfig of a SCG, if the random access is performed during PSCellChange execution and upon sending SCG RRCReconfigurationComplete.

Accordingly, the embodiments herein provide methods for handling self-optimization in a wireless network. The method includes configuring or applying, by a network device, a configuration for a UE with at least one triggering condition. Further, the method includes sending, by the network device, a RRC Reconfiguration including the configuration to the UE upon receiving a UE capability information from the UE. Further, the method includes receiving, by the network device, at least one of: indication of at least one of a Successful PSCell Addition and a Successful PSCell Change from the UE, reporting information about at least one of the Successful PSCell Addition and the Successful PSCell Change based on at least one threshold including an identifier of a PCell, an identifier of a source PSCell, an identifier of a target PSCell for a Conditional PSCell Change (CPC), a PSCell identifier of a Secondary Cell Group (SCG) in a Conditional PSCell Addition (CPA), a serving cell measurement result, a neighbour cell measurement result, a Bluetooth measurement result, a Wireless Local Area Network (WLAN) measurement result, location information, a measurement information for a delay on the SCG in information about the at least one of the Successful PSCell Addition and the Successful PSCell ChangeSPAR and the SPCR, and time elapsed between a CPAC execution towards a target cell and a corresponding latest CPAC configuration received for a selected target cell, indication of at least one of a T304-cause, a T310-cause, and a T312-cause based on the at least one threshold satisfied in the Successful PSCell Change, and indication of a T304-cause based on the at least one threshold satisfied in the Successful PSCell Addition.

In an embodiment, the triggering condition includes at least one of a T310 triggering condition, a T312 triggering condition, and a T304 triggering condition.

Accordingly, the embodiments herein provide methods for handling self-optimization in a wireless network. The method includes detecting, by a UE, a SCG failure at the UE. Further, the method includes indicating, by the UE, a SCG failure information to a network device upon detecting the SCG failure, wherein the SCG failure information comprises a failure during transition to activated, a PSCell measurement cycle, a time elapsed from being deactivated till transition to activated, whether the UE was performing at least one of a radio link monitoring (RLM) and a beam monitoring (BM) in a deactivated state, a CPC failure related information, and a CPA failure related information.

In an embodiment, the method includes detecting, by the UE, a random access due to SCG activation at the UE. Further, the method includes storing, by the UE, a RA report comprising at least one of a RA purpose as the SCG-activation and a SCG-activation-RA-cause upon detecting the SCG activation at the UE. Further, the method includes sending, by the UE, the RA report to the network device.

Accordingly, the embodiments herein provide a UE including a controller coupled with a processor and a memory. The controller is configured to configure or apply a configuration at the UE to log and report information about at least one of a Successful PSCell Addition and a Successful PSCell Change through an otherConfig including at least one threshold in a RRC Reconfiguration. The configuration is configured by a network device. Further, the controller is configured to store information about at least one of the Successful PSCell Addition and the Successful PSCell Change at the UE during at least one of a PSCell change and a PSCell addition and upon exceeding the at least one threshold.

Accordingly, the embodiments herein provide a network device including a controller coupled with a processor and a memory. The controller is configured to configure or apply a configuration for a UE with at least one triggering condition. Further, the controller is configured to send a RRC Reconfiguration including the configuration to the UE upon receiving a UE capability information from the UE. Further, the controller is configured to receive at least one of: indication of at least one of a Successful PSCell Addition and a Successful PSCell Change from the UE, reporting information about at least one of the Successful PSCell Addition and the Successful PSCell Change based on at least one threshold including an identifier of a PCell, an identifier of a source PSCell, an identifier of a target PSCell for a Conditional PSCell Change (CPC), a PSCell identifier of a Secondary Cell Group (SCG) in a Conditional PSCell Addition (CPA), a serving cell measurement result, a neighbour cell measurement result, a Bluetooth measurement result, a Wireless Local Area Network (WLAN) measurement result, location information, a measurement information for a delay on the SCG in information about the at least one of the Successful PSCell Addition and the Successful PSCell ChangeSPAR and the SPCR, and time elapsed between a CPAC execution towards a target cell and a corresponding latest CPAC configuration received for a selected target cell, indication of at least one of a T304-cause, a T310-cause, and a T312-cause based on the at least one threshold satisfied in the Successful PSCell Change, and indication of a T304-cause based on the at least one threshold satisfied in the Successful PSCell Addition.

Accordingly, the embodiments herein provide a UE including a controller coupled with a processor and a memory. The controller is configured to detect a SCG failure at the UE. Further, the controller is configured to indicate a SCG failure information to a network device upon detecting the SCG failure, wherein the SCG failure information comprises a failure during transition to activated, a PSCell measurement cycle, a time elapsed from being deactivated till transition to activated, whether the UE was performing at least one of a RLM and a BM in a deactivated state, a CPC failure related information, and a CPA failure related information.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

The present disclosure provides an effective and efficient method for performing self-optimization for a plurality of scenarios in wireless networks.

Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates an overview of a wireless network for handling self-optimization, according to embodiments as disclosed herein;

FIG. 2 shows various hardware components of a UE, according to the embodiments as disclosed herein;

FIG. 3 shows various hardware components of a network device, according to the embodiments as disclosed herein;

FIG. 4 is a flow chart illustrating a method, implemented by the UE, for handling the self-optimization in the wireless network, according to embodiments as disclosed herein;

FIG. 5 is a flow chart illustrating a method, implemented by the UE, for handling the self-optimization in the wireless network while detecting a SCG failure at the UE, according to embodiments as disclosed herein;

FIG. 6 is a flow chart illustrating a method, implemented by the UE, for handling RA report during SCG activation, according to embodiments as disclosed herein;

FIG. 7 is a flow chart illustrating a method, implemented by the network device, for handling the self-optimization in the wireless network, according to embodiments as disclosed herein;

FIG. 8 depicts a process for handling SCG failure information, according to embodiments as disclosed herein;

FIG. 9 depicts a process for SCell Addition Report (SPAR)/Successful PSCell Change Report (SPCR) logging, according to embodiments as disclosed herein;

FIG. 10 is a flow chart illustrating a method, implemented by the UE, for handling the self-optimization in the wireless network while deleting the configuration at the UE during the RRC reestablishment procedure or the RRC Resume procedure, according to embodiments as disclosed herein; and

FIG. 11 is a flow chart illustrating a method, implemented by the UE, for handling the self-optimization in the wireless network while determining whether the random access procedure is performed, according to embodiments as disclosed herein.

### MODE FOR THE INVENTION

Dual Connectivity: Dual connectivity or more technically multi-radio dual connectivity is specified by a Third Generation Partnership Project (3GPP) in specifications such as technical specification (TS) 37.340. A summary of the details on the dual connectivity is given below.

A Next-Generation Radio Access Network (NG-RAN) supports Multi-Radio Dual Connectivity (MR-DC) operation whereby a user equipment (UE) in a radio resource control (RRC) connected is configured to utilize radio resources provided by two distinct schedulers, located in two different NG-RAN nodes connected via a non-ideal backhaul, one providing NR (New Radio) access and the other one providing either E-UTRA (Evolved UMTS Terrestrial Radio Access) or NR access. One node acts as a master node (MN) and the other as a secondary node (SN). The MN and the SN are connected via a network interface and at least the MN is connected to a core network. The NG-RAN supports a NG-RAN E-UTRA-NR Dual Connectivity (NGEN-DC), in which the UE is connected to one ng-eNB (a E-UTRA base station that can connect to a 5G core) that acts as the MN and one gNB (e.g., 5G base station) that acts as the SN. The NG-RAN also supports NR-E-UTRA Dual Connectivity (NE-DC), in which the UE is connected to one gNB that acts as the MN and one ng-eNB that acts as the SN. The cellgroup associated with the MN is called as a Master Cell Group (MCG) and the cellgroup associated with the SN is called as the Secondary Cell Group (SCG). The primary cell of the MCG is called as a PCell and the primary cell of the SCG is called as the PSCell. The MN adds the SCG using PSCell Addition. The SN or the MN uses the PSCell Change to perform the SCG mobility where the PSCell is changed. In the NR, Radio Access Network (RAN) uses RRCReconfiguration message including Reconfiguration WithSync IE to perform PSCell Addition or PSCell Change.

From R17 onwards, the gNB may activate or deactivate a Secondary Cell Group (SCG) using radio resource control (RRC) message. The UE may perform random access during SCG activation based on certain conditions as described in the 3GPP specifications like TS 38.331. The network may explicitly or implicitly configure the UE not to perform random access upon the PSCell Change or the PSCell Addition when the SCG is deactivated. The PSCell is the cell in which the UE performs random access when performing the Reconfiguration with Sync procedure, if the random access has to be performed.

SCG Failure handling: The UE sends SCGFailure Information to report SCG failures to the MN. The purpose of this procedure is to inform the MN about an SCG failure experienced by the UE. That is, any of SCG radio link failure, failure of SCG reconfiguration with sync, SCG configuration failure for a RRC message on SRB3, SCG integrity check failure, and consistent uplink LBT failures on the PSCell for operation with shared spectrum channel access in the NR.

PSCell change and PSCell Addition: The PSCell change can occur due to mobility and may or may not be associated with the Secondary Node Change (SN change). The Secondary Node Change procedure can be initiated either by the MN or the SN and used to transfer a UE context from a source SN to a target SN and to change the SCG configuration in the UE from one SN to another.

A Conditional PSCell Change (CPC) is defined as a PSCell change that is executed by the UE, when execution condition(s) is met. The UE starts evaluating the execution condition(s) upon receiving the CPC configuration, and stops evaluating the execution condition(s) once PSCell change is triggered. Intra-SN CPC without MN involvement, inter-SN CPC initiated either by MN or SN are supported.

The following principles apply to the CPC:
a. The CPC configuration contains a configuration of CPC candidate PSCell(s) and execution condition(s) and may contain the MN configuration for inter-SN CPC.
b. An execution condition may comprise of one or two trigger condition(s) (CPC events A3/A5, as defined in TS 38.331). Only single RS type is supported and at most two different trigger quantities (e.g., Reference Signal Received Power (RSRP), Reference Signal Received Quality (RSRQ), and Signal Interference Noise Ratio (SINR), etc.) can be configured simultaneously for the evaluation of CPC execution condition of a single candidate PSCell.
c. Before any CPC execution condition is satisfied, upon reception of the PSCell change command or the PCell change command, the UE executes the PSCell change procedure as described in clause 10.3 and 10.5 in TS 37.340 or the PCell change procedure as described in clause 9.2.3.2 in TS 38.300 or clause 10.1.2.1 in TS 36.300, regardless of any previously received CPC configuration. Upon the successful completion of PSCell change procedure or PCell change procedure, the UE releases all stored CPC configurations.
d. While executing the CPC, the UE is not required to continue evaluating the execution condition of other candidate PSCell(s).
e. Once the CPC procedure is executed successfully, the UE releases all stored CPC configurations.
f. Upon the release of SCG, the UE releases the stored CPC configurations.

The MN adds the PSCell during a PSCell addition procedure. The PSCell addition procedure that is executed only when PSCell addition condition(s) are met is called Conditional PSCell Addition (CPA). The PSCell change or the PSCell Addition for the UE (e.g., NR UE) may be triggered after receiving RRCReconfiguration message for the SCG including reconfiguration WithSync IE, or while executing a Reconfiguration WithSync procedure in case of the CPA/CPC.

Self-optimization in NR: A 5G NR (new radio) radio access network (also known as NG-RAN (Next Generation Radio Network)) comprises of a number of NR base stations knows as gNBs. The gNBs can be connected to each other through a Xn interface, and will be connected to various core network elements like AMF (Access and Mobility Management Function), UPF (User Plane Function) etc. Further, the gNBs can be divided into two physical entities named CU (Centralized Unit) and DU (Distributed Unit). The CU provides support for the higher layers of the protocol stack such as SDAP (Session Data Application Protocol), PDCP (Packet Data Convergence Protocol) and RRC (Radio Resource Control), while the DU provides support for the lower layers of the protocol stack such as RLC (Radio Link Control), MAC (Medium Access Control) and Physical layer. Each gNB can have multiple cells serving multiple UEs (User Equipment). There are a large number of methods and configuration parameters used in the NG-RAN. Especially, it is a very difficult task to identify the most optimal radio parameters and operators used to resort to manual techniques like drive tests to identify the parameters.

However, such manual parameter tuning is a costly operation since it depends on a lot of factors like the number of users, number of neighbors, maximum throughput in the cell, average throughput in the cell etc. Further, whenever a neighbor gNB is installed or a new service is introduced, many of these manual operations need to be repeated. To resolve this problem, the 3GPP has introduced Self-Organizing Networks (SON) techniques in the wireless technologies like NR. The SON was first introduced in 3GPP release 9, in LTE. SON solutions can be divided into three categories: Self-Configuration, Self-Optimization and Self-Healing. The SON architecture can be a centralized, distributed or a hybrid solution.

From TS 38.300 V17.0.0, Mobility Robustness Optimization aims at detecting and enabling correction of following problems:
a. Connection failure due to intra-system or inter-system mobility;
b. Inter-system Unnecessary handover (HO) (too early inter-system HO from NR to E-UTRAN with no radio link failure); and
c. Inter-system HO ping-pong.

Non-Public Network (NPN): A Non-Public Network (NPN) is a network for non-public use (as in TS 22.261), which can be deployed as
a. a Stand-alone Non-Public Network (SNPN) when not relying on network functions provided by a Public Land Mobile Network (PLMN); or
b. a Public Network Integrated (PNI) NPN when relying on the support of a PLMN. Additional details on NR-U can be found in the 3GPP specifications like TS 38.331, TS38.300, TS 38.304 etc. R17 V17.1.0 of the specifications is considered as background.

NR-UE: A NR UE may operate in an unlicensed spectrum. The NR-UE enables both uplink and downlink operation in unlicensed bands. The NR-UE supports LBT (Listen-Before-Talk) to provide simultaneous operations in the spectrum which may be used by other NR operators or Wi-Fi access points. Additional details on the NR-UE can be found in 3gpp specifications like TS 38.331, TS38.300, TS 38.321 etc. R17 V17.1.0 of the specification is considered as background.

It is desired to address the above mentioned disadvantages or other short comings or at least provide a useful alternative.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve methods for handling self-optimization in a wireless network. The method includes configuring or applying a configuration at a UE to log and report information about at least one of a Successful PSCell Addition and a Successful PSCell Change through an otherConfig including at least one threshold in a RRC reconfiguration. The configuration is configured by a network device. Further, the method includes storing, by the UE, information about at least one of the Successful PSCell Addition and the Successful PSCell Change at the UE during at least one of a PSCell change and a PSCell addition and upon exceeding the at least one threshold.

The method can used for performing self-optimization (and self-planning or self-healing or any aspects of a Self-Organizing Network (SON), wherever applicable) for a plurality of scenarios in the wireless network. The reporting has been enhanced for MRO and MDT for scenarios, such as, but not limited to, SCG Failure handling, Successful PSCell Addition Report, Successful PSCell Change Report, Conditional PSCell Addition, Conditional PSCell change, SCG activation, NPN, NR-U, and so on. The method can be used to reduce the resource wastage.

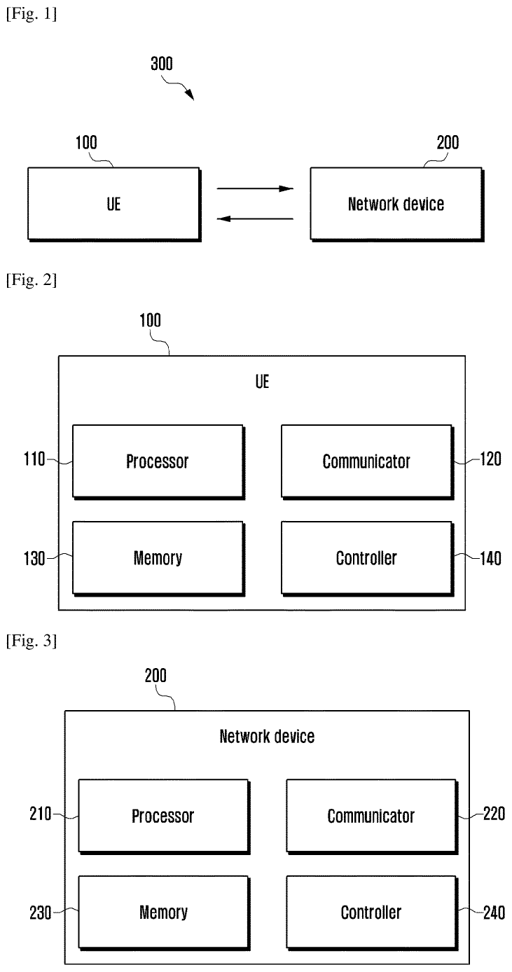

Referring now to the drawings, and more particularly to FIGS. 1 through 11, where similar reference characters denote corresponding features consistently throughout the figures, there are shown at least one embodiment.

FIG. 1 illustrates an overview of a wireless network (300) for handling self-optimization, according to embodiments as disclosed herein. The wireless network (300) can be, for example, but not limited to a fourth generation (4G) network, a fifth generation (5G) network, an Open Radio Access Network (ORAN) or the like. In an embodiment, the wireless network (300) includes a UE (100) and a network device (200). The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network device (200) can be, for example, but not limited to a gNB, a eNB, a new radio (NR) trans-receiver or the like.

The UE (100) configures or apply a configuration at the UE (100) to log and report information about the Successful PSCell Addition and the Successful PSCell Change through an otherConfig including a threshold in a RRC Reconfiguration. The OtherConfig is an information element (IE) used in the NR for the configuration for the thresholds for reporting information about the Successful PSCell Addition and the Successful PSCell Change. There may be other IE used in different technologies. There can be multiple thresholds configured in the same OtherConfig 1E. Similarly, there may be other RRC messages (for e.g. RRC Resume) which configures the OtherConfig including the thresholds for reporting information about the Successful PSCell Addition and the Successful PSCell Change. The configuration is configured by the network device (200). In an embodiment, the UE (100) receives a capability request from the network device (200). The network device (200) can be a Radio Access Network device such as gNB. Based on the capability request, the UE (100) sends a UE capability information to the network device (200). The UE capability information includes a single bit to inform the network device (200) that the UE (100) is capable of storing and reporting information about the Successful PSCellChange and the Successful PSCell Addition. Further, the UE (100) receives a RRC Reconfiguration including the configuration from the network device (200) in a RRC information element (IE) OtherConfig. Based on the RRC Reconfiguration, the UE (100) configures the configuration at the UE (100). Though, the RRC Reconfiguration is used to illustrate the configuration of OtherConfig, it may be included in other RRC messages such as NR RRC Resume message. In the NR, the configuration may be received in a IE successPSCell-Config. That is, successPSCell-Config includes configuration for the UE (100) to report the successful PSCell addition/change information to the network device (200).

The threshold is based on a RRC timer T310 or T312 applied in (i.e. used in) a source PSCell, configured by a source PSCell or any of an earlier PSCells and T304 configured by a target PSCell. The information about Successful PSCell Addition and the Successful PSCell Change are stored upon determining the timer is greater than the threshold. The threshold can be, for example, but not limited to the T310 threshold, the T312 threshold, and the T304 threshold. The thresholds may be given as percentage. The information about the Successful PSCell Addition and the Successful PSCell Change can be logged separately, i.e. in separate reports or can be logged in the same report, for e.g. Successful PSCell Report (SPR). The SPR helps the network device to identify the near failure scenarios of the PSCellChange and the PSCellAddition, thereby enabling the network device (200) to rectify the issues proactively, before they occur.

In an embodiment, the timers T310, T312 are started in a source PSCell before the PSCellChange. T310 is started upon detecting physical layer problems for the PSCell. T312 is started if the UE (100) has reported measurements and the network device (200) has configured the UE (100) to start T312 for the measurement report, while the T310 in the PSCell is running. The T304 is started in a target PSCell after receiving PSCellChange or PSCellAddition command. Once the PSCellChange or PSCellAddition is successful, the UE (100) compares elapsed value of timer T310/T312/T304 to the configured thresholds and if the elapsed value is greater than the threshold SPR is logged. The timers T310/T312 are configured by the source PSCell or any of the earlier PSCells (i.e. when the UE was connected to a different PSCell change after the SCG was added and has moved to the current source PSCell), and are applied in the source PSCell. If the ratio between the value of the elapsed time of the timer T310 and the configured value of the timer T310 which was applied in the source cell is greater than the configured threshold for the T310, the UE (100) considers the threshold for T310 is exceeded. If the T312 associated to the measurement identity of the target cell was running at the time of initiating the execution of the reconfiguration with sync procedure for the SCG and if the ratio between the value of the elapsed time of the timer T312 and the configured value of the timer T312, applied in the source SCG cell is greater than configured threshold for T312, the UE (100) considers the threshold for T312 is exceeded. If the ratio between the value of the elapsed time of the timer T304 and the configured value of the timer T304, included in the last applied RRCReconfiguration message including the reconfiguration WithSync for SCG, is greater than the configured threshold for T304, the UE (100) considers the threshold for T304 is exceeded.

Further, the UE (100) stores the Successful PSCell Addition and the Successful PSCell Change at the UE (100) during the PSCell change and the PSCell addition and upon exceeding the threshold.

In an embodiment, the storing is performed upon successfully completing random access procedure when one or more of the thresholds are exceeded if the random access is performed during PSCellChange execution or PSCellAddition execution.

In an embodiment, when one or more of the thresholds are exceeded, and the random access is not performed during PSCellChange execution or PSCellAddition execution, the storing is performed upon sending SCG RRCReconfigurationComplete. For example, this may be captured in TS 38.331 as follows: If the UE (100) was configured with successPSCell-Config when connected to the source PSCell; perform the actions for the successful PSCell addition/change report determination, upon successfully completing the Random Access procedure, if triggered for the reconfiguration WithSync in spCellConfig of the SCG; otherwise upon sending SCG ReconfigurationComplete.

In an embodiment, when one or more of the thresholds are exceeded, and the random access is not performed during the PSCellChange execution or PSCellAddition execution, the storing is performed upon sending SCG RRCReconfigurationComplete successfully during the PSCellChange execution or PSCellAddition execution.

In an embodiment, when one or more of the thresholds are exceeded, during the PSCellChange execution or PSCellAddition execution, the storing is performed upon sending SCG RRCReconfigurationComplete successfully during the PSCellChange execution or PSCellAddition execution.

In an embodiment, when one or more of the thresholds are exceeded, and the random access is not performed during PSCellChange execution or PSCellAddition execution, the storing of SPR is performed upon receiving SCG RRCReconfiguration including Reconfiguration WithSync successfully.

In an embodiment, when one or more of the thresholds are exceeded, and the random access is not performed during PSCellChange execution or PSCellAddition execution, the storing of SPR is performed upon successfully acquiring the downlink synchronisation.

In an embodiment, when one or more of the thresholds are exceeded, and the random access is not performed during PSCellChange execution or PSCellAddition execution, the storing of SPR is performed upon successfully completing the PSCellChange procedure or PSCellAddition procedure.

In an embodiment, if the random access is not performed during PSCellChange execution or PSCellAddition execution, the UE (200) avoids storing the SPR upon successfully completing the PSCellChange procedure or PSCellAddition procedure irrespective of whether the thresholds are exceeded. For example, this may be captured in TS 38.331 as follows: If the UE (100) was configured with successPSCell-Config when connected to the source PSCell; performs the actions for the successful PSCell addition/change report determination, upon successfully completing the Random Access procedure, if triggered for the reconfiguration WithSync in spCellConfig of the SCG.

In an embodiment, T304 thresholds may not be exceeded when the random access is not send.

In an embodiment, the random access is not performed during PSCellChange or PSCell addition execution if the target PSCell is deactivated when the PSCellChange or PSCell addition.

In an embodiment, the UE (100) determines whether to perform random access upon a PSCellChange for the above embodiments based on the below section in TS 38.331:
if the scg-State is not included in the RRCReconfiguration or RRCResume message containing the RRCReconfiguration message:
3> perform SCG activation as specified in 5.3.5.13a;
3> if reconfigurationWithSync was included in spCellConfig in nr-SCG:
4> initiate the Random Access procedure on the PSCell, as specified in TS 38.321;
3> else if the SCG was deactivated before the reception of the NR RRC message containing the RRCReconfiguration message:
4> if bfd-and-RLM was not configured to true before the reception of the RRCReconfiguration or RRCResume message containing the RRCReconfiguration message; or
4> if lower layers indicate that a Random Access procedure is needed for SCG activation:
5> initiate the Random Access procedure on the PSCell, as specified in TS 38.321;
4> else the procedure ends;
3> else the procedure ends;

In an embodiment, the UE (100) stores at least one of: an identifier of a PCell, an identifier of the source PSCell, an identifier of a target PSCell for a CPC, a PSCell identifier of the SCG in the CPA, a serving cell measurement result, a neighbour cell measurement result, a Bluetooth measurement result, a WLAN measurement result, location information, a measurement information for a delay on the SCG in the Successful PSCell Addition and the Successful PSCell Change, and time elapsed between the CPAC execution towards the target cell and the corresponding latest CPAC configuration received for the selected target cell. In another embodiment, the UE (100) indicates at least one of a T304-cause, a T310-cause, and a T312-cause based on the threshold satisfied in the Successful PSCell Change. In another embodiment, the UE (100) indicates the T304-cause based on the threshold satisfied in the Successful PSCell Addition.

In an embodiment, the neighbour cell measurement result is stored for all the neighbours in the SCG measurement objects configured by both MN and SN. In an embodiment, the neighbour cell measurements results stored include the SCG neighbour cell measurements performed by the UE (100) till the SCG Reconfiguration Complete is send. In an embodiment, the neighbour cell measurements results stored include the SCG neighbour cell measurements performed by the UE (100) till random access is successfully performed when the random access is performed for PSCellChange or PSCellAddition. In an embodiment, the neighbour cell measurement result is stored for all the neighbours in the MCG measurement objects configured by the MN. In an embodiment, the neighbour cell measurements results stored for the MCG neighbour cell measurements are those measurements performed by the UE (100) till SCG Reconfiguration Complete is send. In an embodiment, the neighbour cell measurements results stored for the MCG neighbour cell measurements are the measurements performed by the UE (100) till the random access is successfully performed when the random access is performed for PSCellChange or PSCellAddition.

In an embodiment, the neighbour cell measurement result is stored for all the neighbours in the SCG measurement objects configured by the PCell or any of the earlier PCells of MN and configured by the PSCell or any of the earlier PSCells SN. The UE (100) includes neighbour cell measurements applied in the SCG cell in the SPR. In an embodiment, the neighbour cell measurement result is stored for all the neighbours in the MCG measurement objects configured by the PCell or any of the earlier PCells. The UE (100) includes neighbour cell measurements for the NR or E-UTRA measurement objects applied in the MCG cell, in the SPR.

In another embodiment, the UE (100) indicates the Successful PSCell Addition and the Successful PSCell Change to the network device (200). In another embodiment, the UE (100) reports the information about the Successful PSCell Addition and the Successful PSCell Change based on the threshold.

In another embodiment, the UE (100) deletes the configuration at the UE (100) during a RRC reestablishment procedure and a RRC Resume procedure. This clearing of configuration ensures that only near failure scenarios are considered and the configuration is consistent with the current parameters used by the UE (100). Once the RRC Reestablishment or RRC Resume is successful, the UE (100) doesn't perform SPR logging unless the configuration is again provided by the network device (200). In an embodiment, the UE (100) detects the SCG failure at the UE (100). Upon detecting the SCG failure, the UE (100) indicates the SCG failure information to the network device (200). The SCG failure information includes a failure during transition to activated, a PSCell measurement cycle, a time elapsed from being deactivated till transition to activated, whether the UE (100) was performing at least one of a RLM and a BM in a deactivated state, a CPC failure related information, and a CPA failure related information.

Further, the UE (100) detects the random access due to SCG activation at the UE (100). The UE (100) stores a random access (RA) report comprising at least one of a RA purpose as the SCG-activation and a SCG-activation-RA-cause upon detecting the SCG activation at the UE (100). The UE (100) sends the RA report to the network device (200).

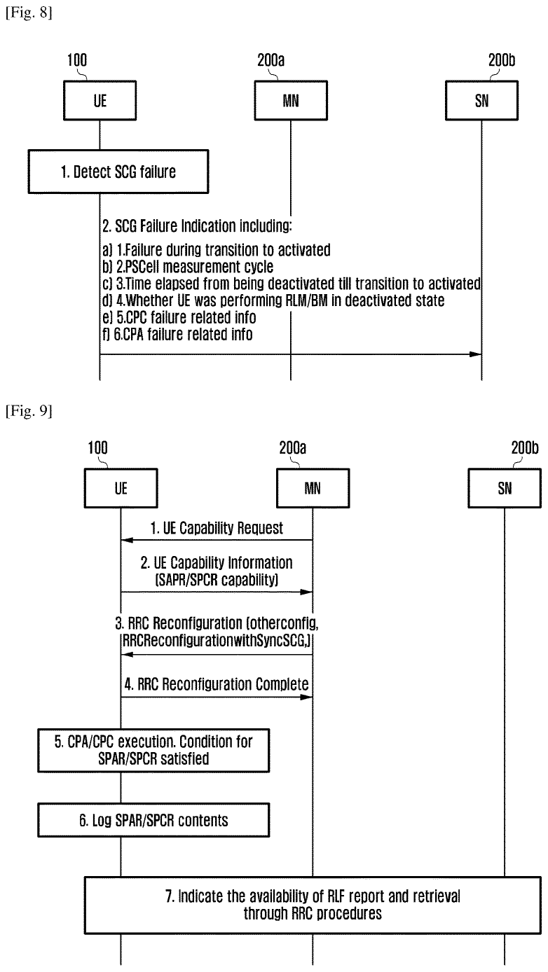

SCG Failure Handling Reporting for SON (as depicted in FIG. 8): In an embodiment, if the UE (100) faces the SCG failure while being in a SCG deactivated state, for instance, while transitioning to activated, the UE (100) includes a current SCG state and also an indication that the SCG failure occurred while transitioning to the SCG activated state in SCG Failure information (e.g., RRC message SCGFailureInformation or the like) send to the MN (200a) (as shown in FIG. 8). The UE (100) further includes whether it was performing radio link monitoring and/or beam monitoring while in the SCG deactivated state in the SCG Failure information. The UE (100) may also include the PSCell measurement cycle for SCG deactivated state in the SCG Failure information. The UE (100) also logs the above information in radio link failure report and informs the network device (200) on requested by the network device (200). In an embodiment, the UE (100) logs the information in the radio link failure report only when SCG Failure information cannot be send. In an embodiment, the UE (100) may log and store the SCG failure information with above data. In an embodiment, if the SCG failure information could not be send due to MCG transmission is suspended, the UE (100) logs the above information in a Radio Link Failure (RLF) report.

In an embodiment, the UE (100) logs an indication whether there is the handover (HO) after the UE (100) is moved to the SCG deactivated before the SCG failure occurred in the SCG Failure information or in the radio link failure report. In an embodiment, the UE (100) includes the time elapsed between moving to the SCG deactivated till the SCG failure has occurred in the SCG failure information or the radio link failure report.

### Successful PSCell Addition Report (SPAR) and Successful PSCell Change Report (SPCR) for SON (as Depicted in FIG. 9):

Capability: The UE (e.g., NR UE, or the like) (100) (which is capable of Successful PSCell Addition Report (SPAR) or Successful PSCell Addition) sends its capability for storage and delivery of SPAR to the network device (e.g., gNB or the like) (200). The NR UE (100) (which is capable of Successful PSCell Change Report (SPCR) or the Successful PSCell Change) sends its capability for storage and delivery of SPCR to the network device (200).

In an embodiment, a single capability bit may be used for indicating the capability of the SPAR and the SPCR. In an embodiment, there may be different capability bits for the SPAR and the SPCR.

Configuration: The network device (200) (e.g., gNB in the NR and eNB in the Long Term Evolution (LTE)) may configure the UE (100) to log and report the SPAR or the SPCR through the otherConfig in the RRC reconfiguration. Once configured, the UE (100) stores the reports during PSCell change or PSCell addition as per configuration. In an embodiment, during the RRC Reestablishment or RRC Resume, the UE (100) may delete the configuration.

In an embodiment, the UE (100) may be configured to report information about successful PSCell Addition or successful PSCell change based on one or more thresholds. The threshold could be based on (NR or LTE) RRC timers like T304, T310 or T312. If the elapsed timer for T304/T310/T312 is greater than the threshold, the UE (100) logs the successful PSCell addition or successful PSCell change reports. In other words, the timers T310, T312 are started in the source PSCell before the PSCellChange. The T304 is started in target PSCell after receiving PSCellChange or PSCellAddition command. Once the PSCellChange or PSCellAddition is successful, the UE (100) compares elapsed value of timer T310/T312/T304 to the configured thresholds and if the elapsed value is greater than the threshold SPR is logged. The timers T304/T310/T312 are defined in TS 38.331 specification.

The UE (100) may indicate the T304-cause, the T310-cause, T312-cause based on the threshold satisfied in the Successful PSCell Change report. If the ratio between the value of the elapsed time of the timer T304 and the value of the T304 timer applied in the target cell is greater than threshold percentage for T304, if included in the SPR Configuration received before executing the last reconfiguration with sync, the UE (100) considers t304-criteria is met and sets t304-cause as true. If the ratio between the value of the elapsed time of the timer T310 and the value of the T310 timer applied in source cell is greater than threshold percentage for T310, if included in the SPR Configuration received before executing the last reconfiguration with sync, the UE (100) considers t310-criteria is met and sets t310-cause as true. If the T312 associated to the measurement identity of the target cell was running at the time of PSCell Change and the ratio between the value of the elapsed time of the timer T312 and the value of the T312 timer applied in source cell is greater than threshold percentage for T312, if included in the SPR Configuration received before executing the last reconfiguration with sync, the UE (100) considers t312-criteria is met and sets t312-cause as true. The UE (100) may indicate the T304-cause, based on the threshold satisfied in Successful PSCell Addition report. In the successful PSCell Addition or PSCell change reports, the UE (100) may log the identifier of PCell and the PSCell identifiers. The UE (100) logs the source PSCell and target PSCell identifies for the CPC, and the PSCell identifier of the added SCG in CPA. The UE (100) also logs the measurement results, including serving and neighbor measurements, the Bluetooth or the WLAN measurements and the location information. The UE (100) also logs the measurements for delay on SCG in the successful PSCell Addition or PSCell change reports.

In an embodiment, the UE (100) logs whether the SCG was activated or deactivated upon the PSCell addition or the PSCell change in the successful PSCell Addition reports or successful PSCell change reports. The UE (100) logs the received SCG status (whether SCG status was received and if so the status received) in the RRC Reconfiguration message for the PSCell addition or the PSCell change in the successful PSCell Addition reports or successful PSCell change reports.

In addition, the UE (100) may also indicate the duration when there was an uplink (UL) data in a SCG bearer, but the SCG was deactivated and if there is interruption for PSCell bearers in the successful PSCell Addition reports or successful PSCell change reports. In an embodiment, the UE (100) logs this information in other reports, for e.g. visited PSCell information in the mobility history information.

The UE (100) may indicate that the RA was not performed in the successful PSCell Addition reports or the successful PSCellChangeReport when the SCG status is deactivated after PSCell Change and PSCell Addition and network device (200) has informed that RA is not needed.

Conditional PSCell Addition (CPA) Reporting for SON: On detecting the RLF during the CPA or detecting triggering conditions for the SPAR are satisfied, the UE (100) may include an indication whether the neighbor cell is a candidate for conditional PSCell Addition, the list of cells (cell global identity (CGI) and TAC or physical cell identity (PCI) if CGI is not available) that were part of candidate PSCells in the CPA configuration, time elapsed between CPA configuration (last RRC Reconfiguration with CPA condition) and CPA execution (i.e. when the execution condition is fulfilled and MN RRC Reconfiguration complete message including SN RRC Reconfiguration Complete is send), conditions that were configured and the conditions that were satisfied, in the SCG Failure information during RLF or in SPAR during a successful PSCell Addition. The UE (100) may also include these information in the MCG RLF report for failure case, if the SCG failure information is not send during a SCG RLF.

In an embodiment, for each visited cell in mobility history information, for each visited PSCell, the UE (100) indicates the time elapsed since last reconfiguration for CPA was received and till the time when PSCell was successfully added.

Conditional PSCell Change (CPC) Reporting for SON: On detecting RLF during CPC, the UE (100) may include an indication whether the neighbor cell is a candidate for conditional PSCell change, the list of cells (cell global identity (CGI) and TAC or physical cell identity (PCI) if the CGI is not available) that were part of candidate PSCells in the CPC configuration, time elapsed between CPC configuration (last RRC Reconfiguration with CPA condition) and CPC execution (i.e. when the execution condition is fulfilled and MN RRC Reconfiguration complete message including SN RRC Reconfiguration Complete is send), conditions that were configured and the conditions that were satisfied in the SCG Failure information. The UE (100) may also include the information in the MCG RLF report, if the SCG failure information has not been send. The UE (100) may also include the information in successful PSCell Change reports.

Random Access Reporting: On performing random access during SCG activation, the UE (100) logs and reports to the network device (200) that the random access is performed for the SCG activation. Further, the UE (100) may log the reason for the random access which was performed during the SCG activation, and in an embodiment the reason for the random access is that the UE (100) was not configured for performing (and the UE (100) was not performing) radio link monitoring and beam failure detection while SCG was deactivated. In an embodiment, the reason for the random access is a request from the lower layer.

In an embodiment, the UE (100) may set raPurpose-r16 in random access report (in 5G NR, var-RAReport) is scg-activation.

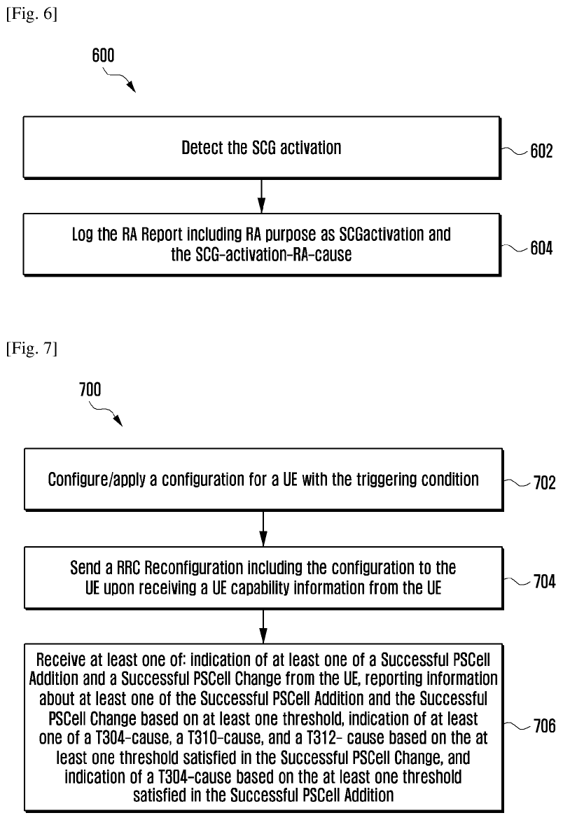

A sample structure including the enhanced random access report is depicted below (and also depicted in FIG. 6).

```
  RA-Report-r16 ::= SEQUENCE {
  cellId-r16 CHOICE {
  cellGlobalId-r16 CGI-Info-Logging-r16,
  pci-arfcn-r16 SEQUENCE {
  physCellId-r16 PhysCellId,
  carrierFreq-r16 ARFCN-ValueNR
  }
  },
  ra-InformationCommon-r16 RA-InformationCommon-r16 OPTIONAL,
  raPurpose-r16 ENUMERATED {accessRelated, beamFailureRecovery, reconfigura-
tionWithSync, ulUnSynchronized, schedulingRequestFailure, noPUCCHRe-
sourceAvailable, requestForOtherSI,
  msg3RequestForOtherSI-r17, scgActivation, spare7, spare6, spare5, spare4, spare3,
  spare2, spare1},
  ...,
  [[
  spCellID-r17 CGI-Info-Logging-r16 OPTIONAL
  ]],
  [[
  Scg-activation-ra-cause ENUMERATED {rlm-bfd-disabled, lowerlayerreq}
  ]]
  }
```

Embodiments herein disclose methods for handling self-optimization in a wireless network (300) by a UE (100). The method includes configuring (or applying) a configuration at the UE (100) to log and report information about at least one of a Successful PSCell Addition and a Successful PSCell Change through an otherConfig including at least one threshold in a radio resource control (RRC) reconfiguration. The configuration is configured by a network device (200). Further, the method includes storing information about at least one of the Successful PSCell Addition and the Successful PSCell Change at the UE during at least one of a PSCell change and a PSCell addition and upon exceeding the at least one threshold.

In an alternate embodiment, the UE (100) does not log and report to the network device (200) that the random access was performed for the SCG activation, if the SCG activation was performed during the handover (i.e., any mobility, for e.g., MN handover or a handover from the NR standalone to NR EN-DC, PSCell change, SN Change etc.).

In another embodiment, the UE (100) does not log and report to the network device (200) that the random access was performed for the SCG activation, if the SCG activation was performed on receiving reconfigurationWithSync included in spCellConfig in nr-SCG (i.e., the UE (100) does not set raPurpose-r16 to SCG activation in the above example) and will log and report to the network device (200) that the random access was performed for SCG activation in all the other cases; (i.e., the UE (100) may set raPurpose-r16 to scgActivation in all other cases in the above example). Other cases referred here are accessRelated, beamFailureRecovery, ulUnSynchronized, schedulingRequestFailure, noPUCCHResourceAvailable, requestForOtherSI, msg3RequestForOtherSI-r17 etc.

In another embodiment, if SCG activation was performed on receiving reconfiguration WithSync included in spCellConfig in nr-SCG, the UE (100) may set raPurpose-r16 as reconfiguration WithSync. In all other cases, where the SCG was activated, the UE (100) may set raPurpose-r16 as accessRelated. In another embodiment, for all other cases where SCG was activated except on receiving reconfigurationwithSync, the UE (100) may set raPurpose-r16 as ulUnSynchronized. Other cases referred here are accessRelated, beamFailureRecovery, ulUnSynchronized, schedulingRequestFailure, noPUCCHResourceAvailable, requestForOtherSI, msg3RequestForOtherSI-r17 etc.

In an embodiment, if the SCG activation is performed on receiving reconfiguration WithSync included in spCellConfig in nr-SCG, the UE (100) may set raPurpose-r16 as reconfiguration WithSync. The UE (100) may include additional information (for e.g., raPurpose-r18 set as segActivation) to inform the network device (200) that SCG activation was performed during this reconfigurationWithSyc. For all other cases where SCG was activated except on receiving reconfigurationwithSync, the UE (100) may set raPurpose-r16 to any value and include the additional information (for e.g., raPurpose-r18 or raPurpose-r19) to inform the network device (200) that SCG activation was performed. Other cases referred here are accessRelated, beamFailureRecovery, ulUnSynchronized, schedulingRequestFailure, noPUCCHResourceAvailable, requestForOtherSI, and msg3RequestForOtherSI-r17 etc.

The network device (200) ignores raPurpose-r16 field if it receives additional information (for e.g., raPurpose-r18 or raPurpose-r19) included as it is for SCG activation and does not receive raPurpose-r16 as reconfigurationWithSyc. The network device (200) ignores raPurpose-r16 field if it receives additional information (for e.g., raPurpose-r18 or raPurpose-r19) as it is for SCG activation and receives raPurpose-r16 as one of accessRelated, beamFailureRecovery, ulUnSynchronized, schedulingRequestFailure, noPUCCHResourceAvailable, requestForOtherSI, msg3RequestForOtherSI-r17.

NR-U handling: For both dual connectivity and single connectivity in NR-U, the UE (100) may log indication of a LBT failure in RA-Report. When there is the LBT failure, the UE (100) may also add additional information to identify the issue in detail. The UE (100) can report RSSI and channel occupancy measurements in the RLF-Report and a Connection Establishment Report (CEF) report. This may be reported in RA-Report also. The UE (100) may also log and report the percentage of LBT failures, interruption time in data transmission and channel occupancy measurements in logged measurement report for MRO and MLB in NR-U. In mobility history information, the UE (100) may log details about the presence of other NR-U cells or other Wi-Fi cells in the same frequency.

Handling of NPN: In an embodiment, for the UE (100) operating in NPN (while storing the following reports: RLF report, RACH report, Successful Handover Report, Successful PSCell change report, Successful PSCell Addition report), the UE (100) stores also the NPN identifier of the NPN where the UE was registered when the report is stored. The UE (100) may store the information in a variable called npn-IdentityInfoList.

In an embodiment, when the UE (100) receives request to report any of the above reports in the RRC message (like UE Information Request), the UE (100) includes the corresponding report in a RRC message like UE Information Response if the identity of registered NPN is included in npn-IdentityInfoList stored in the report. In an embodiment, if the UE (100) has any of the above reports available and if the identity of registered NPN is included in npn-IdentityInfoList stored in report, the UE (100) includes an indication that above reports are available in RRC Setup Complete message or RRC Resume Complete message or RRC Reestablishment Complete message.

In an embodiment, the identifier may be PNI-NPN identity, if the NPN is a Public Network Integrated NPN. If the NPN is SNPN, the identity can be SNPN identity.

FIG. 2 shows various hardware components of the UE (100), according to the embodiments as disclosed herein. In an embodiment, the UE (100) includes a processor (110), a communicator (120), a memory (130) and a controller (140). The processor (110) is coupled with the communicator (120), the memory (130) and the controller (140).

The controller (140) configures or applies the configuration at the UE (100) to log and report information about the Successful PSCell Addition and the Successful PSCell Change through the otherConfig including the threshold in the RRC Reconfiguration. The configuration is configured by the network device (200). In an embodiment, the controller (140) receives the capability request from the network device (200). Further, the controller (140) sends the UE capability information to the network device (200) based on the capability request. The UE capability information includes the single bit to inform the network device (200) that the UE (100) is capable of storing and reporting information about the Successful PSCellChange and the Successful PSCell Addition. Further, the controller (140) receives the RRC Reconfiguration including the configuration from the network device (200) in the RRC information element (IE) OtherConfig. Based on the RRC Reconfiguration, the controller (140) configures the configuration at the UE (100).

The threshold is based on the RRC timer T310 or T312 applied in the source PSCell, configured by the source PSCell or any of an earlier PSCells and T304 configured by a target PSCell. The Successful PSCell Addition and the Successful PSCell Change is stored upon determining a timer is greater than the threshold. The threshold can be, for example, but not limited to the T310 threshold, the T312 threshold, and the T304 threshold.

The logging is performed for the T310 threshold and the T312 thresholds upon successfully completing the Random Access procedure, while triggering for the reconfiguration WithSync in spCellConfig of a SCG. The logging is performed for the T304 threshold upon successfully completing a Random Access procedure, while triggering for a reconfiguration WithSync in spCellConfig of the SCG.

Further, the controller (140) stores the Successful PSCell Addition and the Successful PSCell Change at the UE (100) during the PSCell change and the PSCell addition and upon exceeding the threshold.

In an embodiment, the controller (140) stores at least one of: the identifier of the PCell, the identifier of the source PSCell, the identifier of the target PSCell for the CPC, the PSCell identifier of the SCG in the CPA, the serving cell measurement result, the neighbour cell measurement result, the Bluetooth measurement result, the WLAN measurement result, location information, the measurement information for the delay on the SCG in the at least one of the Successful PSCell Addition and the Successful PSCell Change, and time elapsed between the CPAC execution towards the target cell and the corresponding latest CPAC configuration received for the selected target cell. In another embodiment, the controller (140) indicates at least one of the T304-cause, the T310-cause, and the T312-cause based on the threshold satisfied in the Successful PSCell Change. In another embodiment, the controller (140) indicates the T304-cause based on the threshold satisfied in the Successful PSCell Addition.

In another embodiment, the controller (140) indicates the Successful PSCell Addition and the Successful PSCell Change to the network device (200). In another embodiment, the controller (140) reports the information about the Successful PSCell Addition and the Successful PSCell Change based on the threshold. In another embodiment, the controller (140) deletes the configuration at the UE (100) during a RRC reestablishment procedure and a RRC Resume procedure.

In an embodiment, the controller (140) detects the SCG failure at the UE (100). Upon detecting the SCG failure, the controller (140) indicates the SCG failure information to the network device (200). The SCG failure information includes a failure during transition to activated, a PSCell measurement cycle, a time elapsed from being deactivated till transition to activated, whether the UE (100) was performing at least one of a RLM and a BM in a deactivated state, a CPC failure related information, and a CPA failure related information.

Further, the controller (140) detects the random access due to SCG activation at the UE (100). The controller (140) stores a random access (RA) report comprising at least one of a RA purpose as the SCG-activation and a SCG-activation-RA-cause upon detecting the SCG activation at the UE (100). The controller (140) sends the RA report to the network device (200).

The controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 3 shows various hardware components of the network device (200), according to the embodiments as disclosed herein. In an embodiment, the network device (200) includes a processor (210), a communicator (220), a memory (230) and a controller (240). The processor (210) is coupled with the communicator (220), the memory (230) and the controller (240).

The controller (240) configures or applies the configuration for the UE (100) with the triggering condition. The triggering condition can be, for example, but not limited to the T310 triggering condition, the T312 triggering condition, and the T304 triggering condition. Further, the controller (240) sends the RRC Reconfiguration including the configuration to the UE (100) upon receiving the UE capability information from the UE (100). Based on the configuration, the controller (240) receives the indication of the Successful PSCell Addition and the Successful PSCell Change from the UE (100), the reporting information about the Successful PSCell Addition and the Successful PSCell Change based on the threshold including an identifier of a PCell, an identifier of a source PSCell, an identifier of a target PSCell for a Conditional PSCell Change (CPC), a PSCell identifier of a Secondary Cell Group (SCG) in a Conditional PSCell Addition (CPA), a serving cell measurement result, a neighbour cell measurement result, a Bluetooth measurement result, a Wireless Local Area Network (WLAN) measurement result, location information, a measurement information for a delay on the SCG in information about the at least one of the Successful PSCell Addition and the Successful PSCell ChangeSPAR and the SPCR, and time elapsed between a CPAC execution towards a target cell and a corresponding latest CPAC configuration received for a selected target cell, indication of the T304-cause, the T310-cause, and the T312-cause based on the threshold satisfied in the Successful PSCell Change, and indication of the T304-cause based on the threshold satisfied in the Successful PSCell Addition.

The controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 3 shows various hardware components of the network device (200) but it is to be understood that other embodiments are not limited thereon. In other embodiments, the network device (200) may include less or more number of components. Further, the labels or names of the components are used only for illustrative purpose and does not limit the scope of the invention. One or more components can be combined together to perform same or substantially similar function in the network device (200).

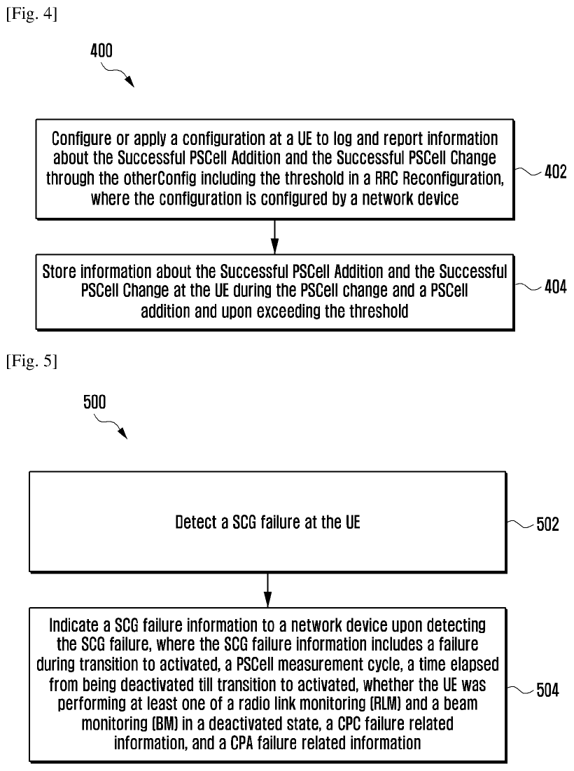

FIG. 4 is a flow chart (400) illustrating a method, implemented by the UE (100), for handling the self-optimization in the wireless network (300), according to embodiments as disclosed herein. The operations (402-404) are handled by the controller (140).

At step 402, the method includes configuring or applying the configuration at the UE (100) to log and report information about the Successful PSCell Addition and the Successful PSCell Change through the otherConfig including the threshold in the RRC reconfiguration. The configuration is configured by the network device (200). At step 404, the method includes storing information about the Successful PSCell Addition and the Successful PSCell Change at the UE (100) during the PSCell change and the PSCell addition and upon exceeding the threshold.

FIG. 5 is a flow chart (500) illustrating a method, implemented by the UE (100), for handling the self-optimization in the wireless network (300) while detecting the SCG failure at the UE (100), according to embodiments as disclosed herein. The operations (502-504) are handled by the controller (140).

At step 502, the method includes detecting the SCG failure at the UE (100). At step 504, the method includes indicating the SCG failure information to the network device (200) upon detecting the SCG failure. The SCG failure information includes the failure during transition to activated, the PSCell measurement cycle, the time elapsed from being deactivated till transition to activated, whether the UE (100) was performing the RLM and the BM in a deactivated state, the CPC failure related information, and the CPA failure related information.

FIG. 6 is a flow chart (600) illustrating a method, implemented by the UE (100), for handling the RA report during SCG activation, according to embodiments as disclosed herein. The operations (602-604) are handled by the controller (140).

At step 602, the method includes detecting the SCG activation. At step 604, the method includes logging the RA Report including the RA purpose as SCG-activation and the SCG-activation-RA-cause.

FIG. 7 is a flow chart (700) illustrating a method, implemented by the network device (200), for handling the self-optimization in the wireless network (300), according to embodiments as disclosed herein. The operations (702-706) are handled by the controller (240).

At step 702, the method includes configuring or applying the configuration for the UE (100) with the triggering condition. At step 704, the method includes sending the RRC Reconfiguration including the configuration to the UE (100) upon receiving the UE capability information from the UE (100). At step 706, the method includes receiving at least one of: indication of at least one of the Successful PSCell Addition and the Successful PSCell Change from the UE (100), reporting information about at least one of the Successful PSCell Addition and the Successful PSCell Change based on the threshold including an identifier of a PCell, an identifier of a source PSCell, an identifier of a target PSCell for a Conditional PSCell Change (CPC), a PSCell identifier of a Secondary Cell Group (SCG) in a Conditional PSCell Addition (CPA), a serving cell measurement result, a neighbour cell measurement result, a Bluetooth measurement result, a Wireless Local Area Network (WLAN) measurement result, location information, a measurement information for a delay on the SCG in information about the at least one of the Successful PSCell Addition and the Successful PSCell ChangeSPAR and the SPCR, and time elapsed between a CPAC execution towards a target cell and a corresponding latest CPAC configuration received for a selected target cell, indication of at least one of the T304-cause, the T310-cause, and the T312-cause based on the threshold satisfied in the Successful PSCell Change, and indication of the T304-cause based on the threshold satisfied in the Successful PSCell Addition.

FIG. 8 depicts a process for handling SCG failure information, according to embodiments as disclosed herein. At step 1, the UE (100) detects the SCG failure. At step 2, the UE (100) sends the SCG failure indication to a secondary node (SN) (200b). The SCG failure indication includes the failure during transition to activated, the PSCell measurement cycle, the time elapsed from being deactivated till transition to activated, whether the UE was performing RLM/BM in the deactivated state, the CPC failure related information and the CPA failure related information.

FIG. 9 is a sequence diagram illustrating a process for SCell Addition Report (SPAR)/Successful PSCell Change Report (SPCR) logging, according to embodiments as disclosed herein. At step 1, the MN (200a) sends the UE capability request to the UE (100). At step 2, the UE (100) sends the UE capability information including the SAPR capability and SPCR capability to the MN (200a) based on the UE capability request. At step 3, the MN (200a) sends the RRC reconfiguration including the otherconfig and the RRCReconfigurationwithSyncSCG to the UE (100). At step 4, the UE (100) sends the RRC reconfiguration complete to the MN (200a). At step 5, the UE (100) detects the CPA execution or the CPC execution and the condition for SPAR or SPCR is satisfied. At step 7, the UE (100) logs the SPAR contents or the SPCR contents. At step 7, the UE (100) indicates the availability of RLF report and retrieval through the RRC procedures.

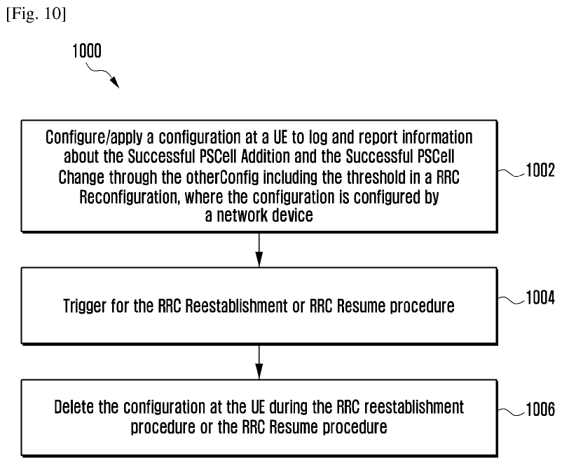

FIG. 10 is a flow chart (1000) illustrating a method, implemented by the UE (100), for handling the self-optimization in the wireless network (300) while deleting the configuration at the UE (100) during the RRC reestablishment procedure or the RRC Resume procedure, according to embodiments as disclosed herein. The operations (1002-1006) are handled by the controller (140).

At 1002, the method includes configuring or applying the configuration at the UE (100) to log and report information about the Successful PSCell Addition and the Successful PSCell Change through the otherConfig including the threshold in the RRC Reconfiguration, where the configuration is configured by the network device (200). At 1004, the method includes triggering for the RRC Reestablishment or the RRC Resume procedure. At 1006, the method includes deleting the configuration at the UE (100) during the RRC reestablishment procedure or the RRC Resume procedure.

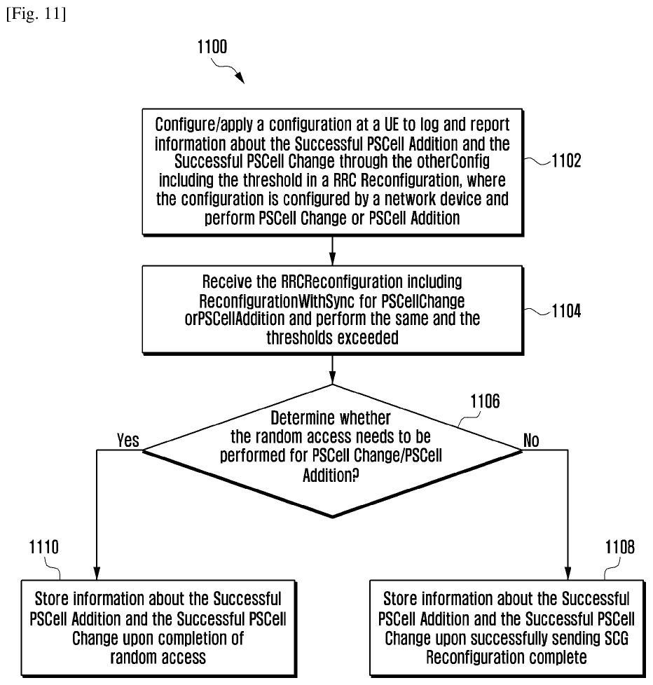

FIG. 11 is a flow chart (1100) illustrating a method, implemented by the UE (100), for handling the self-optimization in the wireless network (300) while determining whether the random access procedure is performed, according to embodiments as disclosed herein. The operations (1102-1108) are handled by the controller (140).

At 1102, the method includes configuring or applying the configuration at the UE (100) to log and report information about the Successful PSCell Addition and the Successful PSCell Change through the otherConfig including the threshold in the RRC Reconfiguration, where the configuration is configured by the network device (200). The method includes performing the PSCell Change or PSCell Addition. At 1104, the method includes receiving the RRCReconfiguration including the Reconfiguration WithSync for the PSCellChange or the PSCellAddition and performing the same and the thresholds exceeded.

At 1106, the method includes determining whether the random access needs to be performed for the PSCell Change or the PSCell Addition? Upon determining that the random access needs to be performed for the PSCell Change/PSCell Addition then, at 1108, the method includes storing the information about the Successful PSCell Addition and the Successful PSCell Change upon completion of random access. Upon determining that the random access does not need to be performed for the PSCell Change/PSCell Addition then, at 1110, the method includes storing the information about the Successful PSCell Addition and the Successful PSCell Change upon successfully sending SCG Reconfiguration complete.

The various actions, acts, blocks, steps, or the like in the flow charts (400-700, 1000, and 1100) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1-15. (canceled)

16. A method performed by a terminal in a wireless communication system, the method comprising:
transmitting, to a base station, information indicating whether the terminal supports storage and delivery of a successful primary secondary cell group (SCG) cell (PSCell) change or addition report;
receiving, from the base station, information on a configuration for the terminal to report successful PSCell change or addition information;
based on the information on the configuration, storing the successful PSCell change or addition information; and
transmitting, to the base station, the successful PSCell change or addition report,
wherein the information on the configuration comprises at least one of:
information on a first threshold associated with a first timer,
information on a second threshold associated with a second timer, or
information on a third threshold associated with a third timer.

17. The method of claim 16, further comprising, in case that a ratio between a value of an elapsed time and a configured value is greater than at least one of the first threshold, the second threshold, or the third threshold, storing the successful PSCell change or addition information.

18. The method of claim 16, wherein the successful PSCell change or addition information comprises at least one of:
information on a stand alone non-public network (SNPN) identity,
information on a primary cell (PCell), information on a source PSCell,
information on a target PSCell, information on a neighbor cell,
information on an elapsed time associated with a conditional reconfiguration, or
information on at least one cause, and
wherein the first timer is T304, the second timer is T310, and the third timer is T312.

19. The method of claim 16, further comprising:
transmitting, to the base station, information indicating whether the terminal reports the successful PSCell change or addition report;
in case that the terminal has the successful PSCell change or addition information available and a registered stand alone non-public network (SNPN) identity is included in a list associated with an SNPN identity, including information on an indication of availability of the successful PSCell change or addition report in at least one of a radio resource control (RRC) setup complete message, an RRC reconfiguration complete message, an RRC re-establishment complete message, or an RRC resume complete message; and
in case that the terminal is in an RRC re-establishment procedure or an RRC connection resume procedure, releasing the information on the configuration.

20. A method performed by a base station in a wireless communication system, the method comprising:
receiving, from a terminal, information indicating whether the terminal supports storage and delivery of a successful primary secondary cell group (SCG) cell (PSCell) change or addition report;
transmitting, to the terminal, information on a configuration for the terminal to report successful PSCell change or addition information; and
receiving, from the terminal, the successful PSCell change or addition report,
wherein, the successful PSCell change or addition information is stored by the terminal based on the information on the configuration, and
wherein the information on the configuration comprises at least one of:
information on a first threshold associated with a first timer,
information on a second threshold associated with a second timer, or
information on a third threshold associated with a third timer.

21. The method of claim 21, wherein, in case that a ratio between a value of an elapsed time and a configured value is greater than at least one of the first threshold, the second threshold, or the third threshold, the successful PSCell change or addition information is stored by the terminal,
wherein the successful PSCell change or addition information comprises at least one of:
information on a stand alone non-public network (SNPN) identity,
information on a primary cell (PCell), information on a source PSCell,
information on a target PSCell, information on a neighbor cell,
information on an elapsed time associated with a conditional reconfiguration, or
information on at least one cause, and
wherein the first timer is T304, the second timer is T310, and the third timer is T312.

22. The method of claim 21, further comprising receiving, from the terminal, information indicating whether the terminal reports the successful PSCell change or addition report,
wherein, in case that the terminal has the successful PSCell change or addition information available and a registered stand alone non-public network (SNPN) identity is included in a list associated with an SNPN identity, information on an indication of availability of the successful PSCell change or addition report is included in at least one of a radio resource control (RRC) setup complete message, an RRC reconfiguration complete message, an RRC re-establishment complete message, or an RRC resume complete message, and
wherein, in case that the terminal is in an RRC re-establishment procedure or an RRC connection resume procedure, the information on the configuration is released by the terminal.

23. A terminal in a wireless communication system, the terminal comprising:
a transceiver; and
at least one processor coupled with the transceiver and configured to:
transmit, to a base station, information indicating whether the terminal supports storage and delivery of a successful primary secondary cell group (SCG) cell (PSCell) change or addition report,
receive, from the base station, information on a configuration for the terminal to report successful PSCell change or addition information,
based on the information on the configuration, store the successful PSCell change or addition information, and
transmit, to the base station, the successful PSCell change or addition report,
wherein the information on the configuration comprises at least one of:
information on a first threshold associated with a first timer,
information on a second threshold associated with a second timer, or
information on a third threshold associated with a third timer.

24. The terminal of claim 23, wherein the at least one processor is further configured to, in case that a ratio between a value of an elapsed time and a configured value is greater than at least one of the first threshold, the second threshold, or the third threshold, store the successful PSCell change or addition information.

25. The terminal of claim 23, wherein the successful PSCell change or addition information comprises at least one of:
information on a stand alone non-public network (SNPN) identity,
information on a primary cell (PCell),
information on a source PSCell, information on a target PSCell,
information on a neighbor cell,
information on an elapsed time associated with a conditional reconfiguration, or
information on at least one cause, and
wherein the first timer is T304, the second timer is T310, and the third timer is T312.

26. The terminal of claim 23, wherein the at least one processor is further configured to:
transmit, to the base station, information indicating whether the terminal reports the successful PSCell change or addition report,
in case that the terminal has the successful PSCell change or addition information available and a registered stand alone non-public network (SNPN) identity is included in a list associated with an SNPN identity, include information on an indication of availability of the successful PSCell change or addition report in at least one of a radio resource control (RRC) setup complete message, an RRC reconfiguration complete message, an RRC re-establishment complete message, or an RRC resume complete message, and
in case that the terminal is in an RRC re-establishment procedure or an RRC connection resume procedure, release the information on the configuration.

27. A base station in a wireless communication system, the base station comprising:
a transceiver; and
at least one processor coupled with the transceiver and configured to:
receive, from a terminal, information indicating whether the terminal supports storage and delivery of a successful primary secondary cell group (SCG) cell (PSCell) change or addition report,
transmit, to the terminal, information on a configuration for the terminal to report successful PSCell change or addition information, and
receive, from the terminal, the successful PSCell change or addition report,
wherein, the successful PSCell change or addition information is stored by the terminal based on the information on the configuration, and
wherein the information on the configuration comprises at least one of:
information on a first threshold associated with a first timer,
information on a second threshold associated with a second timer, or
information on a third threshold associated with a third timer.

28. The base station of claim 27, wherein, in case that a ratio between a value of an elapsed time and a configured value is greater than at least one of the first threshold, the second threshold, or the third threshold, the successful PSCell change or addition information is stored by the terminal.

29. The base station of claim 27, wherein the successful PSCell change or addition information comprises at least one of:
information on a stand alone non-public network (SNPN) identity,
information on a primary cell (PCell),
information on a source PSCell, information on a target PSCell,
information on a neighbor cell,
information on an elapsed time associated with a conditional reconfiguration, or
information on at least one cause, and
wherein the first timer is T304, the second timer is T310, and the third timer is T312.

30. The base station of claim 27, wherein the at least one processor is further configured to:
receive, from the terminal, information indicating whether the terminal reports the successful PSCell change or addition report,
wherein, in case that the terminal has the successful PSCell change or addition information available and a registered stand alone non-public network (SNPN) identity is included in a list associated with an SNPN identity, information on an indication of availability of the successful PSCell change or addition report is included in at least one of a radio resource control (RRC) setup complete message, an RRC reconfiguration complete message, an RRC re-establishment complete message, or an RRC resume complete message, and
wherein, in case that the terminal is in an RRC re-establishment procedure or an RRC connection resume procedure, the information on the configuration is released by the terminal.
